(19) United States
(12) Patent Application Publication
(10) Pub. No.: US 2015/0227115 A1
(43) Pub. Date: Aug. 13, 2015

(54) METHOD AND SYSTEM FOR DISPLAYING TIME AND LOCATION AT A COMPUTING DEVICE

(71) Applicant: OPENPEAK INC., BOCA RATON, FL (US)

(72) Inventor: CARSTEN MICHAEL DIETZ, BOYNTON BEACH, FL (US)

(21) Appl. No.: 14/605,347

(22) Filed: Jan. 26, 2015

Related U.S. Application Data
(60) Provisional application No. 61/932,884, filed on Jan. 29, 2014.

(51) Int. Cl. G04G 9/00

(52) U.S. Cl. CPC G04G 9/0076

(57) ABSTRACT

A method and system for displaying time and location elements are described herein. The method includes the step of determining a first location and a first time zone that is assigned to the first location. The method also includes the step of simultaneously displaying a first geographical representation of the first location and a first time element of the first location based on the first time zone. In addition, the method includes the step of determining a second location and a second time zone that is assigned to the second location based on received selection input. The method further includes the step of simultaneously displaying a second geographical representation of the second location and a second time element of the second location based on the second time zone.

### CROSS-REFERENCE TO RELATED APPLICATIONS

This patent application claims priority from U.S. Provisional Patent Application No. 61/932,884, filed on Jan. 29, 2014, which is incorporated herein by reference in its entirety.

### FIELD OF TECHNOLOGY

The present description relates to systems and methods for displaying time and location at a computing device.

### BACKGROUND

Computing devices may perform many useful functions, including the planning of events or trips. For example, an application on a computing device may be used to coordinate a conference call involving participants from multiple locations. As another example, an application on the device may be used to plan a business trip between two or more locations, which may be in different time zones. A user of the device may have to perform such planning tasks frequently, for instance, as part of his or her job. As such, a significant amount of valuable work time may be spent performing the tasks, especially when associated events or trips involve multiple locations around the world.

Performance of these and other functions may be difficult or time-consuming for a user for a variety of reasons. For instance, planning of an event or a trip may require determination of the current time, or other time information, at a certain location. In some applications, this process may be performed in a tedious manner, such as navigation through a complex menu or a manual search of a database. The difficulty may be compounded when multiple locations are involved, and may increase even further for locations in different time zones. Such challenges may be alleviated, however, by a more user-friendly way of accessing and presenting the time information.

### SUMMARY

A method of displaying time and location elements at a computing device is disclosed herein. The method can include the steps of determining a first location and a first time zone that is assigned to the first location and simultaneously displaying a first geographical representation of the first location and a first time element of the first location based on the first time zone. The method may also include the step of determining a second location and a second time zone that is assigned to the second location based on received selection input. In addition, the method may include the step of simultaneously displaying a second geographical representation of the second location and a second time element of the second location based on the second time zone. In one arrangement, the first or second time element can include a current, past, or future time at the first or second location, or a time difference between the current, past, or future time and a reference time.

The method may further include the steps of adjusting the first or second geographical representation and displaying at least a portion of the boundaries of the first time zone or second time zone. In addition, the method may include the steps of—in response to the adjusting—displaying a third time element associated with a third location and displaying at least a portion of the boundaries of a third time zone different from the first and second time zones. In one arrangement, at least a portion of the displayed boundaries of the third time zone may be different from the displayed boundaries of the first or second time zones. Adjusting the geographical representations may include scaling, rotating or scrolling the geographical representations.

The method may also include the steps of determining a route between the first and second locations, determining a route information element, and presenting the route information element. In one embodiment, the route information element may include a travel time associated with the route or an arrival time associated with the route. In another embodiment, the step of presenting the route information element may include superimposing the route information element over the first or second geographical representation when the first or second geographical representation is displayed.

A method of displaying temporal data associated with a location is also disclosed herein. The method may include the steps of determining a first location based on input received at a computing device and determining a first temporal setting that is associated with the first location. Furthermore, the method can include the steps of displaying a first geographical representation of the first location and presenting the first temporal setting associated with the first location while displaying the first geographical representation of the first location. The method may also include the steps of determining a second location based on input received at the computing device and determining a second temporal setting that is associated with the second location. The method can further include the steps of displaying a second geographical representation of the second location and presenting the second temporal setting associated with the second location while displaying the second geographical representation of the second location.

In one arrangement, the steps of presenting the first temporal setting and the second temporal setting may include superimposing the first temporal setting over the first geographical representation when the first geographical representation is displayed and superimposing the second temporal setting over the second geographical representation when the second geographical representation is displayed. In another arrangement, the first geographical representation may be associated with a first time zone and the second geographical representation may be associated with a second time zone. In yet another arrangement, the first temporal setting can be a current, past, or future time associated with the first time zone and the second temporal setting can be a current, past, or future time associated with the second time zone.

The method can also include the steps of displaying at least a portion of the boundaries of the first time zone when the first geographical representation is displayed and displaying at least a portion of the boundaries of the second time zone when the second geographical representation is displayed. The method may further include the steps of adjusting the first or second geographical representation and—in response to the adjusting—displaying at least a portion of the boundaries of a third time zone different from the first and second time zones. In one embodiment, at least a portion of the displayed boundaries of the third time zone may be different from the displayed boundaries of the first or second time zones.

In one arrangement, the first and second locations may be part of a route and the first and second temporal settings may be part of a route representation that at least partially runs along the first and second displayed geographical representations. In another arrangement, the first or second temporal settings can include a travel time associated with the route or an expected arrival time at the second location.

A computing device is also disclosed herein. The computing device may include an interface that is configured to receive input from a user related to location selections. The device may also include a display that may be configured to present viewable elements to the user. In addition, the device may include a processing unit, which may be configured to determine a first location based on input received at the interface, determine a first temporal setting that is associated with the first location, and cause a first geographical representation of the first location to be displayed on the display. The processing unit may also be configured to cause the first temporal setting associated with the first location to be displayed on the display while the first geographical representation of the first location is displayed on the display.

In one arrangement, the display may include the interface or the display and the interface may be part of a combined component. In another arrangement, the processing unit may be further configured to determine time zone boundaries associated with the first location and to cause at least a portion of the time zone boundaries to be displayed on the display. In yet another arrangement, the processing unit may be further configured to cause an adjustment of the first geographical representation and, in response to the adjustment, cause a second temporal setting associated with a second location to be displayed on the display.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a computing device that is capable of displaying time and location.

FIG. 2 illustrates an example of a method for displaying time and location elements on a computing device.

FIG. 3 illustrates an example of a graphical representation and time element associated with a location.

FIG. 4 illustrates an example of graphical representations and time elements associated with two locations.

FIG. 5 illustrates an example of graphical representations, time elements, and time zone boundaries associated with two locations.

FIG. 6 illustrates an example of graphical representations and time elements associated with three locations, displayed on a scaled map enlarged in comparison to the original.

FIG. 7 illustrates an example of graphical representations and time elements associated with three locations, displayed on a scaled map shrunken in comparison to the original.

FIG. 8 illustrates an example of graphical representations, time elements, and time zone boundaries associated with three locations.

FIG. 9 illustrates an example of graphical representations and time elements of two locations and a route information element describing a route between the two locations.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. In addition, components may be communicatively coupled through direct or indirect connections, or a combination thereof. A “computing device” is defined as a component that is configured to perform some process or function for a user and includes both mobile and non-mobile devices. The terms “computer program medium” and “computer readable medium” are defined as one or more non-transitory components that are configured to store instructions that are to be executed by a processing unit.

An “application” or an “app” is defined as a program or programs that perform one or more particular tasks on a computing device. Examples of an application include programs that may present a user interface for interaction with a user or that may run in the background of an operating environment that may not present a user interface while in the background. The term “setting” is defined as a state or condition or some relation to a state or condition. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. In addition, memory may include a combination of removable, permanent, or semi-permanent components.

An “interface” is defined as a component or group of components that enable(s) the device to receive input and to present information, whether through visual, audio, written, tactile or other methods, or any combination of such. A “display” is defined as a component or group of components that enable(s) the device to present information, content, settings, or the like through visual, audio, tactile, or other methods. A display may be separate from an interface, or may include or be combined with one or more interfaces. A “transceiver” is defined as a component or a group of components that enable(s) a device to communicate with one or more different devices, whether through hard-wired connections, wireless connections or a combination of both.

The term “time zone” is defined as a region, contiguous or otherwise, that observes a uniform standard time for legal, commercial, business, or social purposes. A time zone may be defined according to a universally accepted standard, such as “ISO 8601,” which designates time zone boundaries along with time offsets for the zones with respect to a universal reference, such as Coordinated Universal Time (UTC) or Greenwich Mean Time (GMT). In addition, a time zone may be referenced by an accepted name that may not necessarily be part of an official standard, such as the Eastern Time Zone (ET) in the United States. A time zone may also be defined arbitrarily by a user. As an example, an international company with operations in different parts of the United States may group the locations together into a single time zone, such as “American Time,” for scheduling meetings or other purposes.

The term “location” is defined as a domain, such as a city, county, state or country or the like, or as any geographic region, but the term should not necessarily be restricted to refer to a contiguous geographic region. As an example, a location can be a street address or the area specified by a certain postal code, commonly referred to as a “ZIP code.” The term “route” is defined as a direct or indirect path between two or more locations. A “route information element” is defined as a collection of one or more pieces of information related to a route, which may be configured as a listing, visual icon or other representation for display, presentation, or storage of at least a portion of the information. The presentation may be performed through visual, audio, tactile, or other appropriate methods. As an example, the route information element associated with a route between Miami and Denver may specify the originating city of Miami, the destination city of Denver, and an estimated travel time between the two cities and may be configured to be superimposed on a map displayed on a computing device.

The term “superimpose” is defined as placing an object, such as an image, over another object. As an example, on the display of a device, an enlarged view of a city map may be displayed on top of an existing map in response to a user selecting the city on the existing map. As another example, virtual lines that form the boundaries of a time zone may be superimposed on an existing map. The term “adjusting” or “adjustment” is defined as a process in which at least some part of a displayed element is modified in response to input from a viewer or machine to present a different view of the displayed element. The term “scaling” is defined as transforming an object or a view of the object by enlarging or shrinking, generally such that the change in size is performed uniformly in each dimension. As an example of scaling, a map displayed on a computing device may be enlarged to provide a zoomed-in view of a smaller piece of the same map. The term “scrolling” is defined as an action in which a displayed element is translated in one or more particular directions, either one at a time or simultaneously.

A “geographical representation” is defined as a presentation of a geographic region that includes certain features associated with that geographic region. Examples of a geographical representation include maps and globes, which may be presented on any appropriate graphical display. The geographical representation may refer to a portion of or the entire area displayed. It should be noted that multiple geographical representations may appear on the same display. For example, a map of the United States may be considered a geographical representation of the United States. Furthermore, the same map may include geographical representations of the cities of Miami and Denver, due to those two cities being visible on the map. In addition, a second geographical representation may be superimposed over a first geographical representation. For example, when a user selects a certain city on a map, in response, an enlarged version of the city may be displayed over the state or portion of the country in which the city is situated.

A “temporal setting” is defined as a quantity, piece of information, state, or condition related to a time aspect of a location or event. For instance, a current, past, or future time at a location, the scheduled time or duration of an event, or the duration of a trip may be considered temporal settings.

A “time element” may be defined as a collection of one or more pieces of time-related information or temporal settings, which may be configured as a listing, visual icon or other representation for display, presentation, or storage of at least a portion of the information or settings. As noted earlier, the time element may include one or more temporal settings, and the process of forming a time element may include providing values for these temporal settings. Presentation of the time element may be performed through visual, audio, tactile, or other appropriate methods. As an example, the time element may include a clock icon that shows the current time at a location, which may be superimposed on a map displayed on a computing device. In one arrangement, the time-related information may include any appropriate measure of time, including the current, past, or future time at a location, or a time difference between that time and a reference time, such as Universal Coordinated Time (UTC) or Greenwich Mean Time (GMT). In another arrangement, the reference time can be any time specified by a user, program, or application. For instance, the scheduled time of a planned meeting may serve as a reference time, and may be generated automatically by a calendar application or other appropriate methods.

As explained earlier, a user may depend on a computing device for performing tasks such as planning events or trips, which may include determining time information at one or more locations. In some cases, the planning process may be quite time-consuming, particularly when the event or trip involves many locations. The process may be even more laborious when the locations are spread out over the world in different time zones.

A method and system for displaying time and location information at a computing device are described herein to address this problem. In particular, a first location and a first time zone that is assigned to the first location may be determined. In addition, a first geographical representation of the first location and a first time element of the first location based on the first time zone may be simultaneously displayed. Based on received selection input, a second location and a second time zone that is assigned to the second location based on received selection input may be determined. Furthermore, a second geographical representation of the second location and a second time element of the second location based on the second time zone may be simultaneously displayed.

As such, the method and system provide an easy way for time information about one or more locations to be determined and presented. Such a feature may improve the efficiency of tasks performed with computing devices, such as the planning of events or trips. This improvement may benefit the productivity of an organization and may improve overall user experience associated with applications on the devices.

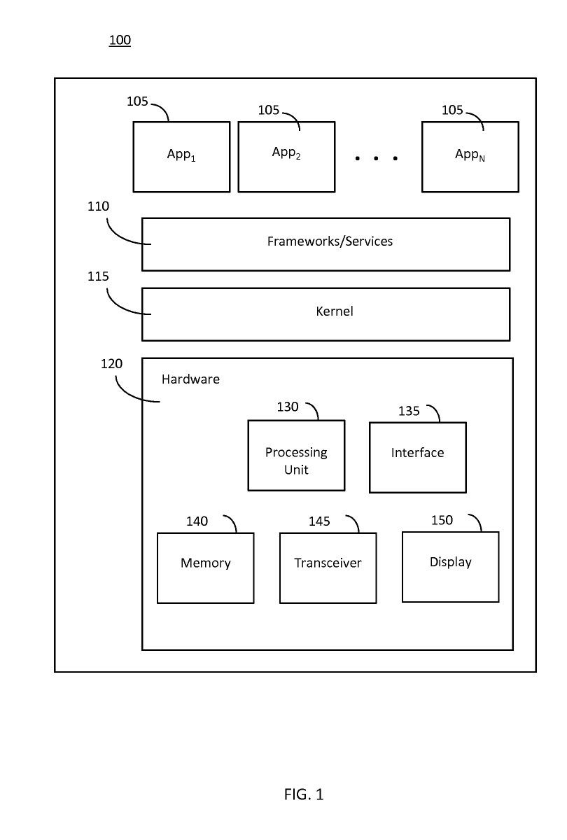

Referring to FIG. 1, an example of a computing device 100 that enables displaying of time and location is shown. The device 100 can include one or more applications 105, which may be completely or partially installed on the device 100 or elsewhere, such as on a server (not shown) to which the device 100 is communicatively coupled. As an example, the computing device 100 may be enabled to cause execution of an application 105 that actually executes at the server.

As is known in the art, the computing device 100 may include a frameworks/services level 110 that provides several abstraction layers that include system interfaces and that facilitate operation of the applications 105 and other functions of the device 100. As is also known in the art, the computing device 100 can include a kernel 115, which provides interfaces for the frameworks/services level 110 to interact with a hardware layer 120. The computing device 100 may further include an operating system and any suitable type of abstraction layers to enable applications that may be installed on the device 100 to interact with the components described here and other elements of the device 100.

As shown in the hardware layer 120, the computing device 100 may include a processing unit 130, and may also include an interface 135, a memory unit 140, a transceiver 145, and a display 150, any of which may be communicatively coupled to the processing unit 130. The interface 135 may include one or more components that are configured to accept input from a user or other device, such as a mouse, a touch screen, a microphone, or any other suitable component. The display 150 may be configured to present data, information or the like to a user or other component and may include, for example, a graphical display, speakers, or any other suitable component. As previously mentioned, the display 150 may be separate from the interface 135, may include the interface 135, or may be combined with one or more interfaces 135. For instance, a touch screen may perform the functionality of both the interface 135 and the display 150. The memory unit 140 may be a single memory unit or may be comprised of multiple memory units that may operate independently or jointly and can include persistent memory, non-persistent memory or both. The transceiver 145 may be configured to support either wired or wireless communications with a variety of components, such as other computing devices, external networks, landline phones, desktop computers or the like, and may be configured to operate in accordance with various protocols. The computing device 100 may include multiple processing units 130, interfaces 135, transceivers 145, and displays 150 to carry out any of the functions described herein.

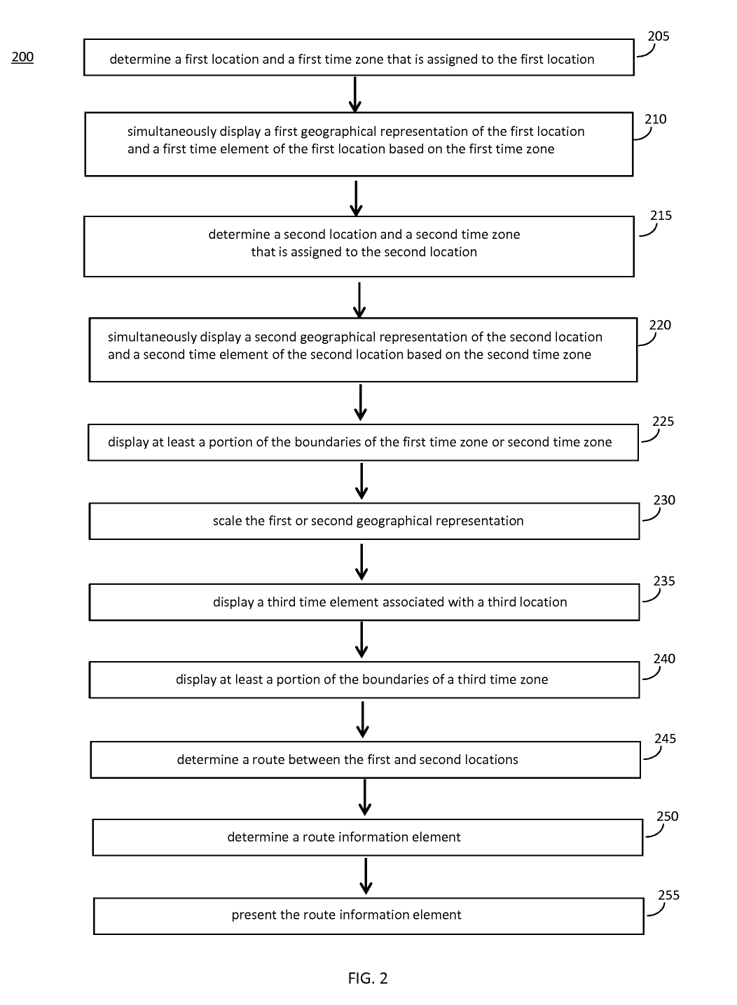

Referring to FIG. 2, a method 200 of displaying time and location at the computing device 100 is shown. It is important to note that the method 200 may include additional or even fewer steps or processes in comparison to what is illustrated in FIG. 2. Moreover, the method 200 is not necessarily limited to the chronological order that is shown in FIG. 2. In describing the method 200, reference may be made to FIGS. 1 and 3-9, although it is understood that the method 200 may be practiced with any other suitable systems, interfaces and components.

At step 205, a first location and a first time zone assigned to the first location may be determined. A first geographical representation of the first location and a first time element of the first location based on the first time zone may be simultaneously displayed at step 210. In addition, a second location and a second time zone assigned to the second location based on received selection input may be determined at step 215. At step 220, a second geographical representation of the second location and a second time element of the second location based on the second time zone may be simultaneously displayed. Furthermore, at step 225, at least a portion of the boundaries of the first or second time zone may be displayed.

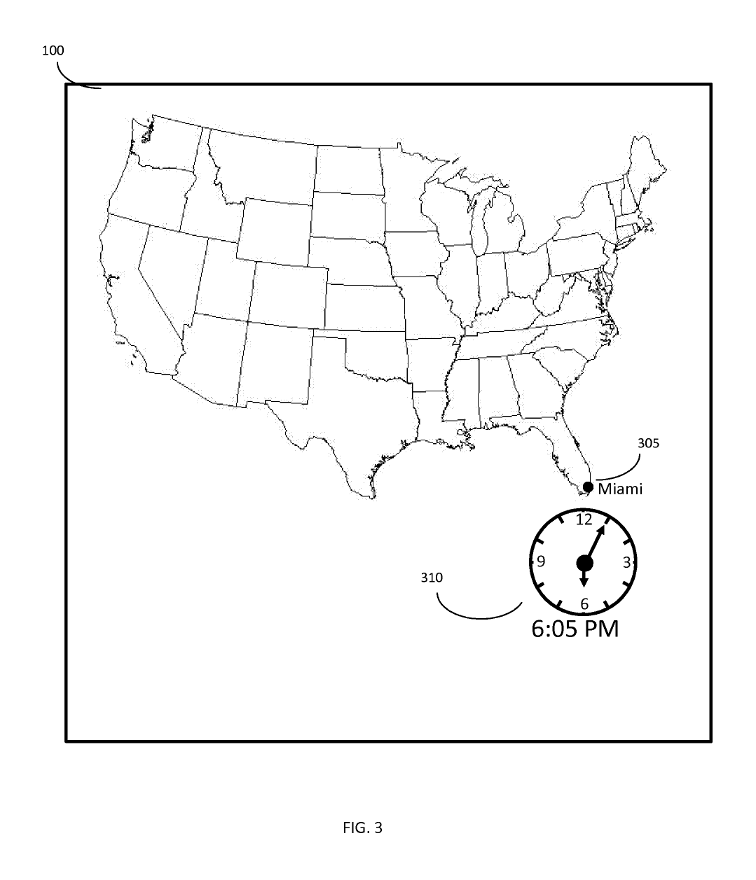

As an example, the determination of the location (first, second, or otherwise) may be based on selection input received at the computing device 100 through any suitable method, including tactile, audio, or visual. In one embodiment, the display 150 may include a touch screen that presents a map that allows a user to specify the location by touching an appropriate place on the map. For instance, referring to FIG. 3, a map of the continental United States is displayed, and a user may specify the location of Miami by touching the display 150 at or near where Miami appears on the map. In one arrangement, the device 100 may determine the location using geographic coordinates corresponding to the touched location along with any appropriate method, such as table look-up or interpolation. In another arrangement, the device 100 may allow for fine tuning of the initial location selection by presenting at the display 150 a selectable list of possible locations in response to the user's initial touching. For instance, if the user touches the map near Miami, a list that includes Miami and other nearby cities, such as Fort Lauderdale and West Palm Beach, may be presented for user selection. In yet another arrangement, the device 100 may allow for such refinement of the initial location choice by presenting at the display 150 and accepting user input on an enlarged map that includes the initial location and surrounding areas. Refinement of the representation may also be accomplished through scaling tools, a practice that is well-known in the art.

In another embodiment, the location may be specified through the interface 135 in any other appropriate manner, including voice input through a microphone, input from an external keyboard or mouse, or through tactile input methods, such as keyboard entry on a touch screen. In yet another embodiment, the location may be received at the device 100 through any wired or wireless communication with the transceiver 145, for instance as part or all of a message or a file. In these and other embodiments, it should be noted that during the input process, the location may be referenced by name or may be specified using geographic coordinates such as latitude, longitude, elevation, GPS coordinates, or any appropriate location identifiers. For instance, a user speaking into a microphone may specify Miami as the location by saying the word “Miami” or by speaking GPS coordinates associated with Miami. In addition, the input may be processed using appropriate tools to perform tasks, such as speech recognition or text parsing to produce the location.

As previously noted, a first time zone associated with the first location may be determined. In one arrangement, the time zone may be determined with the use of a table that includes a list of possible locations and the appropriate time zone identifier for each location. For instance, a table may include the cities of Miami, Chicago, and Denver, and may identify them as being in the Eastern, Central, and Mountain Time Zones, respectively. Such a table should not be so limited, however, and may identify the time zones of those locations in any appropriate manner. For instance, the time zones of the same three cities may also be referenced with respect to Universal Coordinated Time (UTC) as “UTC−5,” “UTC−6,” and “UTC−7.” In this standard notation, the number specifies a number of hours that the time zone is offset from UTC, and the “−” specifies that the time zone is behind UTC. As such, a time zone one hour ahead of UTC would be referred to as “UTC+1.”

In another arrangement, an algorithm may determine the time zone by utilizing geographic coordinates of the location along with pre-determined geographic information about time zone boundaries, such as latitude or longitude. For instance, the Eastern Time Zone may be approximated as locations within the United States that are east of (less than) 84 degrees longitude or some set of longitudinal coordinates. An algorithm may utilize the fact that the longitude of Miami is about 80 degrees to determine that Miami is positioned within the Eastern Time Zone.

A first time element of the first location based on the first time zone may be determined or created. As discussed earlier, the time element can include any number of pieces of appropriate time-related information associated with the first location, including a current, past, or future time at the location, or a time difference between that time and a reference time, such as UTC. In addition, the reference time may also be any specified time, such as the scheduled time of a planned meeting. The time element may also include the name of a time zone associated with the location.

As previously described, a geographical representation may refer to the presentation of a geographic region, such as a map or globe on any appropriate graphical display. As such, a first geographical representation of the first location and the first time element may be simultaneously displayed. In one arrangement, the first geographical representation may be a map of a region that includes the first location, and the first time element may be superimposed on the map. Referring again to FIG. 3, an example embodiment shows a geographical representation 305 of the city of Miami as part of a larger map of the United States. In addition, a time element 310 is simultaneously displayed with the geographical representation 305, in this case a combined analog and digital clock icon that indicates the current time in Miami of 6:05 PM. In this example, the time element 310 may be superimposed over the geographical representation 305, which may be a convenient arrangement for a user.

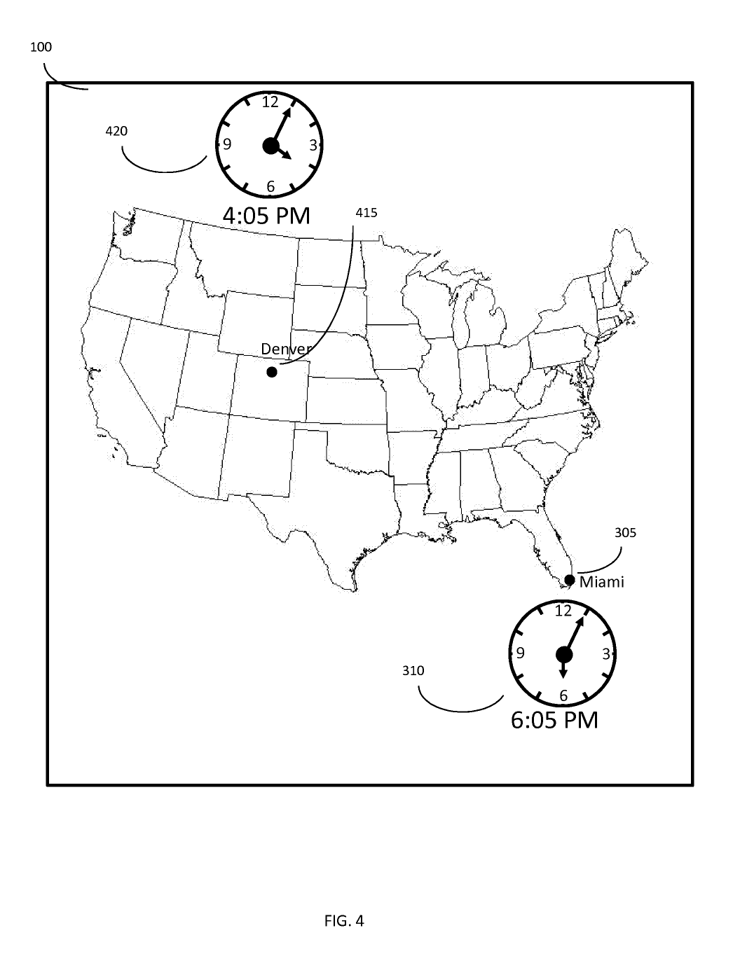

It should be noted that the techniques described above with respect to the first location may be applied for the second location, or any other location. Referring to FIG. 4, an example embodiment shows the first geographical representation 305 and first time element 310 for the first location of Miami, where the current time is 6:05 PM. In addition, for the second location of Denver, a second geographical representation 415 is simultaneously displayed with a second time element 420 that indicates the current time of 4:05 PM, two hours behind the current time in Miami. Note that in this example, both the first and second geographical representations 305 and 415 are shown on the same map. However, this example is not limiting, and geographical representations for the two locations may be displayed in any suitable manner, including the use of two separate or disconnected maps on the display 150.

In one arrangement, the time element that is presented to a user may be automatically updated in accordance with changes that occur with respect to the display of geographic representations. For example, a user may be shown a geographic representation of the eastern seaboard of the United States, and a time element may show the current time of one or more cities that are positioned within this representation, such as the city of Miami from the example above. If the user or some apparatus provides input that causes the display to show a different geographic representation, in response, the time element can be automatically updated to account for the current time that is associated with the new geographic representation. For example, if the display is a touch screen display, the user may scroll the display to the left, which may cause the Pacific coast of the United States to appear, and the time element can be updated to show the current time of one or more cities that sit along this area. In addition, as the display shows areas of the country as the user scrolls to the left, the time element can be updated to show the time in these regions, as well, even if these areas are only temporarily displayed as the user passes them by. This feature may apply to any number and type of geographic representations, and the time element may show other temporal information, other than simply the current time associated with a displayed geographic representation.

In another example, the time element may be based on a reference time, such as the scheduled time of a meeting. For instance, an employee in Miami may touch his location on a map and specify that a meeting take place Friday at 3:00 PM. In order to facilitate the process of inviting a fellow employee located in Denver to join the meeting remotely, the employee in Miami may then touch the location of Denver on the map to produce a time element that is based on the reference time of 3:00 PM. The time element for Denver may include one or more of the time of 1:00 PM (the time in Denver when it is 3:00 PM in Miami), an offset of negative 2 hours, the name of the time zone in which Denver is located (Mountain Time Zone), or any other suitable time indicator. As such, quick and convenient access to this knowledge may facilitate the employee in Miami in the task of planning the meeting. For instance, if company policy requires all employees to return from lunch by 1:00 PM local time, then the potential attendee in Denver should be available for the scheduled meeting. This additional information may also be automatically updated based on changes in the display of geographic representations, as described above.

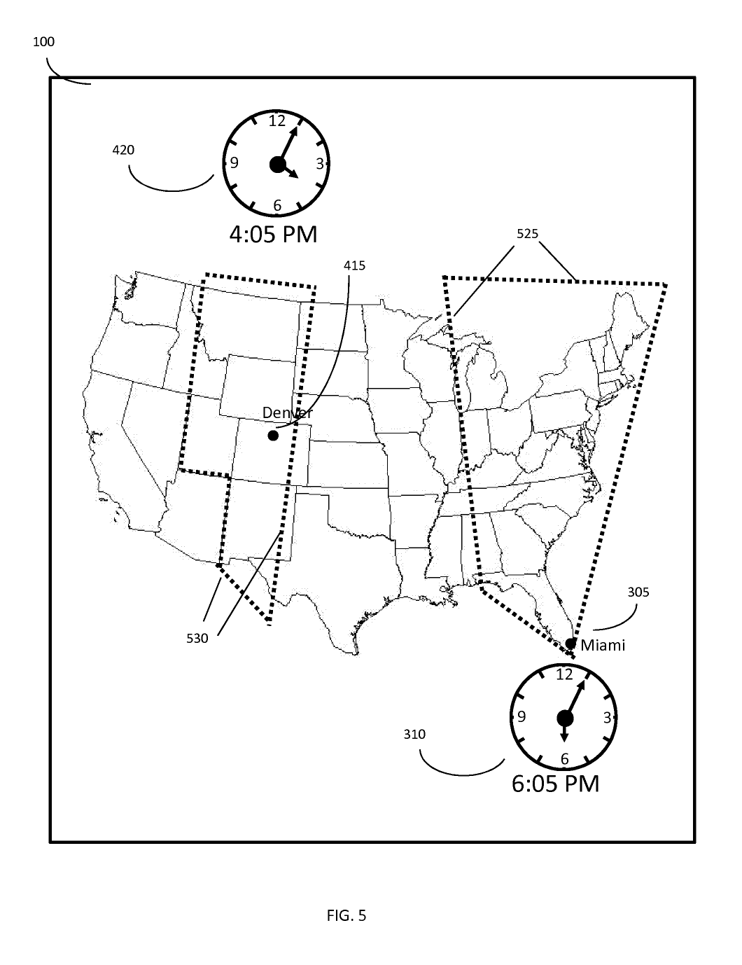

Referring back to the method 200 of FIG. 2, at step 225, at least a portion of the boundaries of the first or second time zone may be displayed, which may be performed by superimposing the boundaries on a map shown in a display. Referring to FIG. 5, as an example, the first time zone boundaries 525 may demarcate the first time zone associated with the first location of Miami, while the second time zone associated with the second location of Denver may be represented by the second time zone boundaries 530. Note in this case that the time zone boundaries 525 and 530 are superimposed on a displayed map, but the displaying of boundaries should not be so limited, as the time zone boundaries may be displayed at any suitable location. For instance, while the display 150 shows an existing map, a new map with the time zone boundaries may be displayed in addition to, or in place of, the existing map. It should also be noted that in FIG. 5 and elsewhere, the time zone boundaries depicted are merely representations of official time zones and are not necessarily meant to accurately depict their coverage areas. The illustrated time zone boundaries are shown to describe examples of the subject matter contained herein.

Displaying of the time zone boundaries may be performed in any suitable manner. In one arrangement, the boundaries for a location may be automatically displayed when the location is selected for any purpose, for instance a user touching the location just to find out what the current time is at the location. In another arrangement, time zone boundaries not necessarily associated with any selected locations may be displayed in addition to, or instead of, the boundaries associated with locations that have been selected for some purpose. In yet another arrangement, all time zone boundaries associated with the entire region shown in the display 150 may be displayed. Such a condition may result automatically as part of the application that displays the map, or may be selected by a user, for example from a menu that may have a setting such as “Show All Time Zones,” or similar.

In addition, the time zone boundaries may be automatically generated when, for example, the user scrolls the display in a particular direction such that the geographic representations associated with a particular time zone comes into view. As another example, when time zone boundaries are generated, a corresponding time element may also be created and displayed such that a user can automatically determine the current time (or some other temporal information) associated with the displayed time zone. Thus, multiple time elements may be displayed along with their corresponding time zone boundaries, and time elements and time zone boundaries may be automatically generated and displayed (or deleted) in response to changes in the display, such as scrolling or scaling.

Returning to FIG. 2, at step 230, the first or second geographical representation may be scaled. In response to the scaling, a third time element associated with a third location may be displayed, as shown at step 235. In step 240, at least a portion of the boundaries of a third time zone associated with the third location may be displayed.

As previously described, scaling of a geographical representation may include enlarging or shrinking the representation such that more or less of the depicted area is displayed. Scaling of an image displayed at the device 100 may be initiated or specified in any appropriate manner, including user input through touch, manual entry, entry using a dialog box, or the like. As an example, a user may touch a map on the display 150 with two fingers, and specify the scaling by spreading out or bringing together the two fingers. As another example, a user may type a scaling ratio (for each of horizontal and vertical directions, or for the two together) on a keyboard at the interface 135 or may enter such a ratio in a dialog box that appears on the display. As yet another example, a mouse included as part of the interface 135 may be used to specify the scaling, which can be selected from a scaling feature that may be shown as part of a geographical representation.

In addition, the scaling may be initiated or specified automatically, for instance, in response to input from a program or an application. For instance, if a map on the display 150 shows the United States only, a calendar application may automatically prompt enlarging of the map to also display Europe in response to a user attempting to schedule a conference call involving participants in the United States and in Europe.

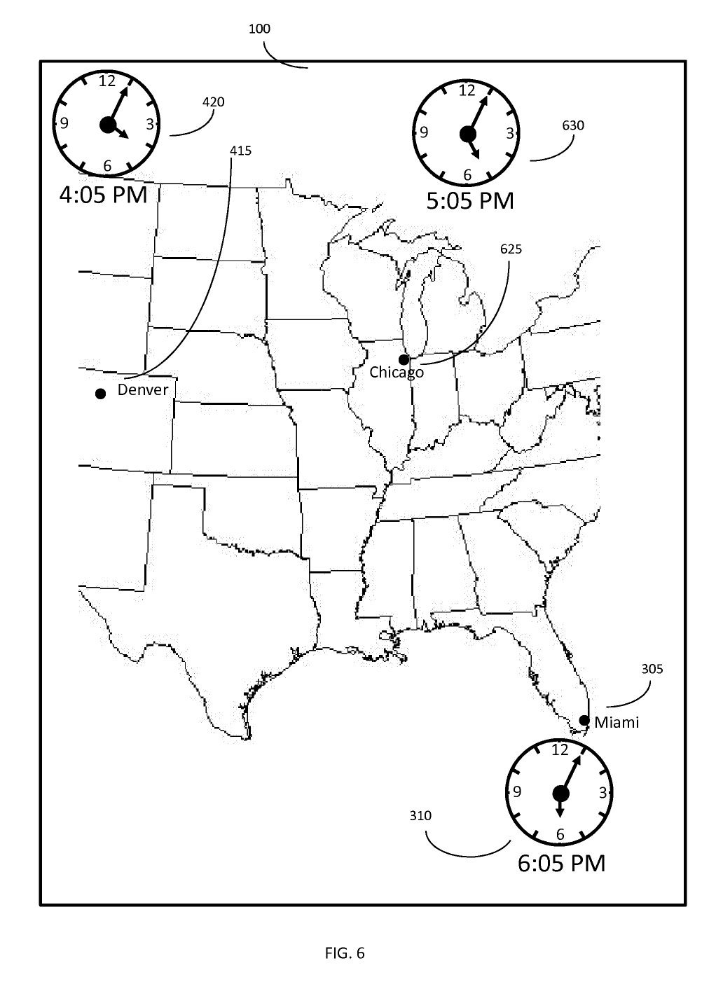

In response to the scaling process, a third geographical representation associated with a third location may be displayed. Referring to the example embodiment shown in FIG. 6, an enlarged version of the map displayed previously in FIG. 4 is shown. In this case, the display has been zoomed in by some degree. The map in FIG. 4 shows geographical representations of the first location of Miami and the second location of Denver (305 and 415, respectively), while the scaled map in FIG. 6 also displays those representations. In addition, the enlarged map in FIG. 6 displays a third geographical representation 625 and third time element 630 associated with a third location, the city of Chicago. Such a process may also be duplicated if the displayed map were reduced or zoomed out, and any suitable number of locations and time elements may be displayed in response to the zooming in or out steps. Moreover, time zone boundaries may also be added or removed to the map display in response to the scaling process.

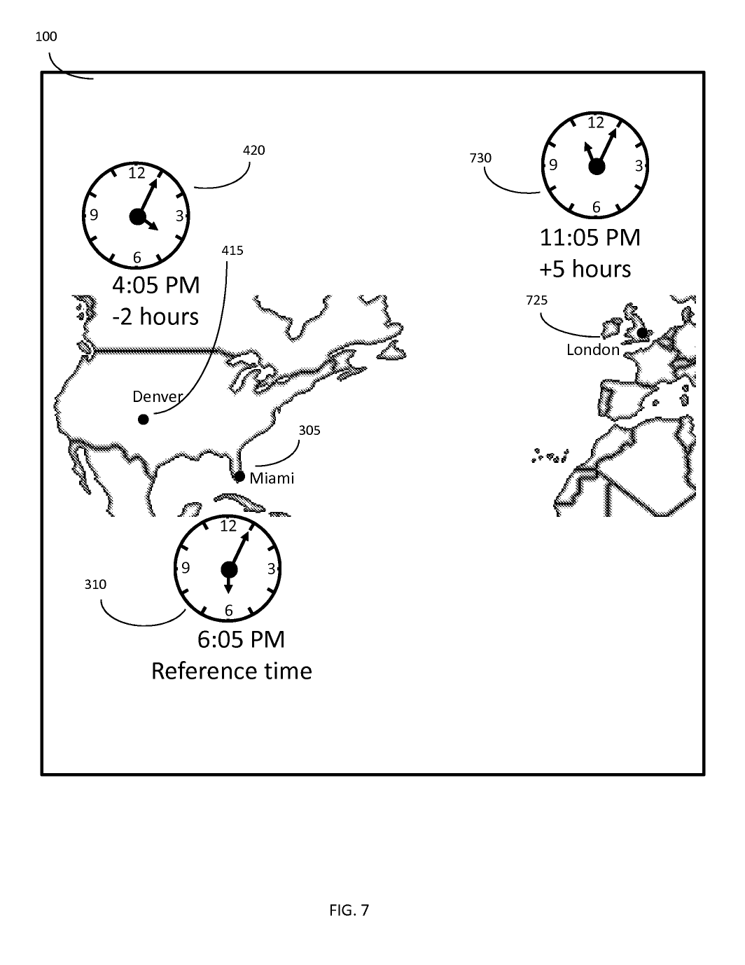

Referring to FIG. 7, an example embodiment shows another scaling of the previous map from FIG. 4, in this case a shrinking of the map such that a larger region is displayed. In this example, a third geographical representation 725 and a third time element 730 associated with a third location of the city of London are displayed at the device 100. It should be noted that a third location may be specified by the user in any appropriate manner or may be specified by a program or application, but should not be limited as such. For instance, the map may be configured such that a key landmark city, like Chicago or London, is always displayed geographically when it is within the region displayed. In addition, it may also be required or specified that the map be zoomed in or out to a certain level (or percentage) for such an automatic display to be performed. It should also be noted that in FIG. 7, the example time elements 310, 420, and 730 illustrate embodiments of a time element that include not only the time, but also a time offset with respect to the reference location of Miami.

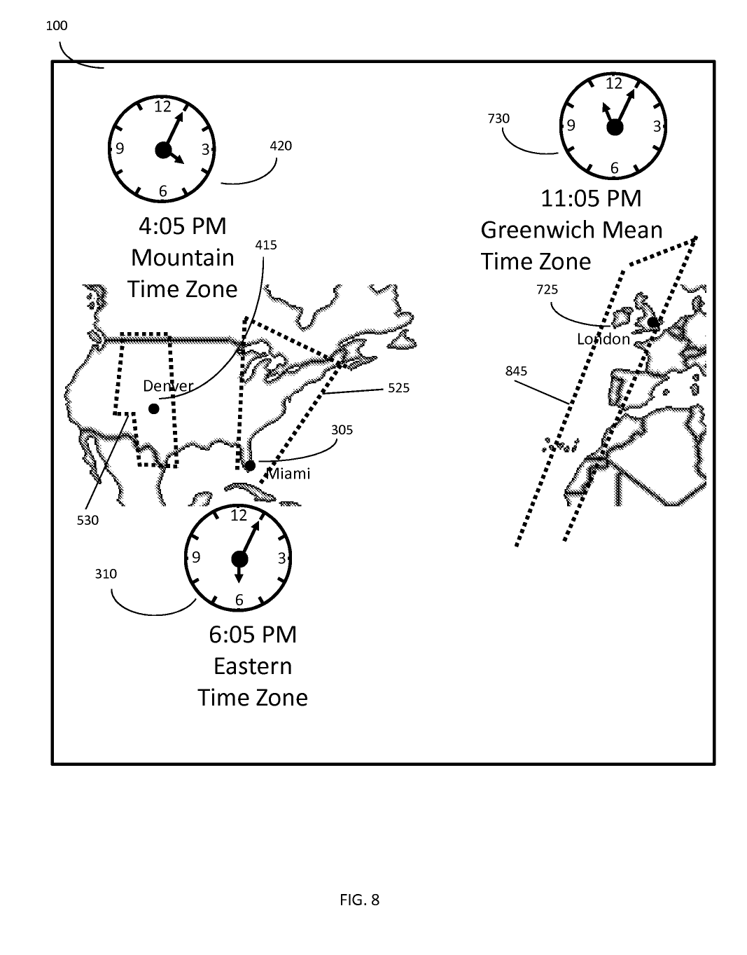

The display of time zone boundaries may be adjusted to accommodate the differences caused by the scaling step. For example, at least a portion of the boundaries of a third time zone associated with the third location may be displayed. Referring to FIG. 8, an example shows a scaled display of a map with first, second, and third locations of Miami, Denver, and London, along with geographic representations (305, 415, and 725 respectively) and time elements (310, 420, and 730 respectively). In addition, time zone boundaries 845 for the third location are displayed, along with time zone boundaries 525 and 530 for the first and second locations. Once again, it should be noted that the displayed boundaries are not necessarily accurate, and are intended to simply illustrate the examples disclosed. It should also be noted that the time elements 310, 420, and 730 illustrate an additional embodiment of a time element that includes the time at the location along with the name of the time zone. Furthermore, as previously described, the time elements may indicate any number of time-related pieces of information and are not limited to the examples shown here. Again, the geographical representations, the time elements and the time zones and their boundaries can be automatically updated as a user scrolls or scales the display, no matter the direction of scrolling or scaling.

In another embodiment, the geographical representation may be adjusted according to user input, which may be received at the device 100 through any previously described techniques. Adjusting may include translation (or scrolling), rotation, skewing, cropping, scaling, or any appropriate action that produces a different geographical display. In one example, a user may touch a map on the display 150 and move his finger along the display. In response, the map may be translated (moved) such that the location originally selected by the user's finger remains under the user's finger while the rest of the map moves to accommodate. In another example, a three-dimensional globe pictured on the display 150 may be rotated in response to touch input from the user. The user input may also be entered manually. For instance, a map or globe on the display 150 may be skewed in either the horizontal or vertical direction according to a set of numbers input into a dialog box.

In response to such an adjustment in the geographical representation, a time element or the displaying of the time element may be updated automatically. As an example, the location that appears at the center of a map may change as a user scrolls the map in any direction. Accordingly, a time element may update automatically to display the time at the location appearing in the map center, even as that location changes. In another example, on a three-dimensional globe display, a time element may include the time in the time zone that currently appears on the longitudinal curve at the front and center of the globe (closest to the viewer). As the display is rotated, a different time zone may rotate into the front and center position, and the time element can be automatically updated to reflect the time in that time zone.

Referring once again to FIG. 2, at step 245, a route between the first and second locations may be determined. At step 250, a route information element may be determined in response, and may be presented at step 255.

As described previously, a route may refer to a direct or indirect path between two or more locations. In this case, the route between the first and second locations may refer to any possible path that may be taken between the two locations using any means of transportation, such as automobile, airplane, train, or the like. In addition, a route may refer to or provide a distance between the two locations. The determination of the route may be performed in any suitable manner. In one arrangement, an application may determine a route that can be traveled by automobile by using knowledge of roads that can connect the two locations along with algorithms to determine the most desirable of such routes in terms of a suitable criterion, such as distance or time of travel. In another arrangement, an application may determine one or more airplane flights that together may enable a person to travel between the two locations and may also select the most desirable of possibilities using various criteria, such as price, departure time, arrival time, total travel time, or the like. It should also be noted that a route should not be restricted to just paths over which a person can travel, as a route may also refer to paths through a network over which data, voice, or other signals can be transmitted.

As noted above, a route information element may be determined and may be presented at any suitable location or on any suitable apparatus, including the display 150 of the device 100 or some other suitable device. For instance, a remote user may be utilizing applications on the device 100 with information being transmitted back to the user for display on a monitor that is not part of the device 100. The presentation of the route information element may include superimposing it over a geographical display, displaying it on a separate map, or any other suitable method.

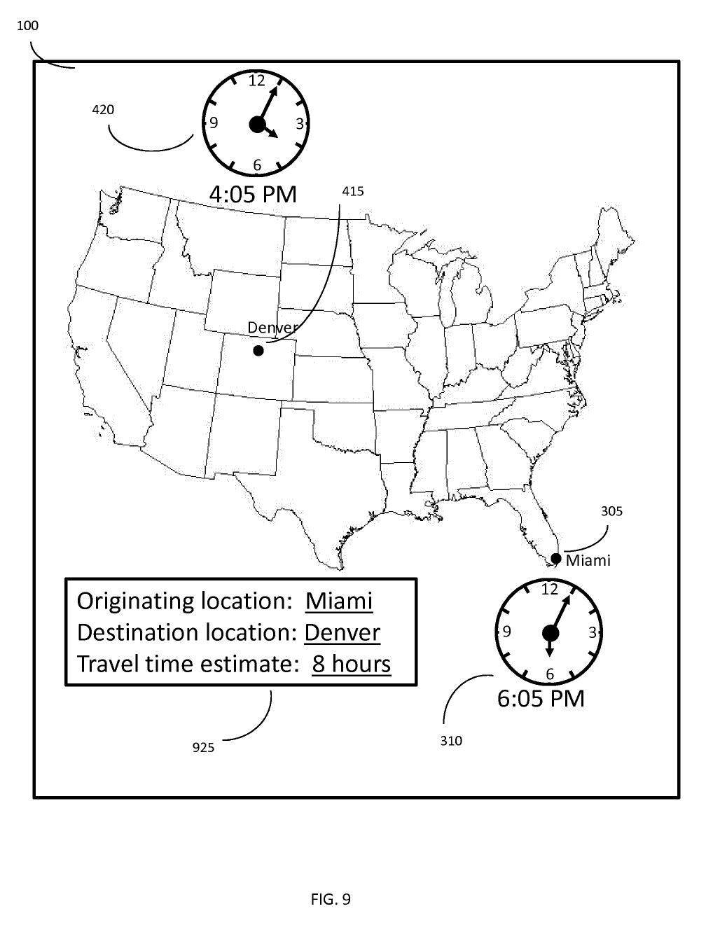

Referring to FIG. 9, an example embodiment shows a route information element 925 associated with a route between Miami and Denver, which is superimposed on a map that includes geographic representations 305 and 415 of Miami and Denver. In this case, the route information element 925 indicates the originating location, destination location, and estimated travel time, but this example is not meant to be limiting. Additional or alternate information, such as flight number(s), road names, directions, or the like may be included as part of the route information element.

In addition, a route representation associated with the route may be formed and displayed in any suitable manner, in addition to or in place of the route information element 925. The route representation (not shown) may include lines that connect the geographic representations 305 and 415, or lines that at least partially run along one or both of them. The lines may be superimposed on the map, or may be displayed in a separate map that illustrates the route.

Additionally, the route representations may follow one or more roads that connect the originating and destination locations or may follow an established air or sea route that does the same. In one particular arrangement, the user may scroll along the route representation, such as by dragging his finger along the route or by simply scrolling along the map shown on the display. In this case, a time element may be displayed that indicates the estimated time along the route based on the part of the route element that is shown and based on normal traffic and weather conditions. As the user continues to scroll along the route, the time element may be automatically updated based on the part of the route element that is displayed. The time element may indicate the amount of time that would normally pass for the part of the route element that is displayed, based on certain averages taken into account, like posted speed limits. If desired, additional factors may be taken into consideration, like weather forecasts for the intended dates of travel or traffic conditions based on the expected time of travel. For example, if the user wishes to drive from Miami to Denver, as the user follows the route element, a time element may show the expected time and duration of travel along a part of the route element in Oklahoma as the user scrolls through that state, assuming that location is along the route. The route representation should not be limited to these arrangements, however, and may include any relevant information about the route as described above or any depiction that serves to illustrate the route.

In another embodiment, a time element may be altered in response to user input and may be displayed accordingly. In one example, a clock that includes the current time at a location may be displayed on a touch-screen map in response to a user touching the location on the map. As the user moves his finger in any direction on the map, the clock may move accordingly to the location currently being touched by the user's finger, and the displayed time on the clock may be altered to reflect the current time at that location. In another example, the clock may be displayed in a fixed location on the map, such as the center of the map. As the user scrolls through the map, the geographic regions displayed on the map may adjust in response, and the displayed time on the clock may be altered to reflect the time of the location that rests underneath the clock. It should be noted that in these examples, any suitable user inputs, time elements, or adjustments may be used, including previously described techniques.

While various embodiments have been described above, it should be understood that they have been presented by way of example only, and not limitation. It will be understood by those skilled in the relevant art(s) that various changes in form and details may be made therein without departing from the spirit and scope of the subject matter as defined in the appended claims. Accordingly, the breadth and scope of the present subject matter should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of displaying time and location elements, comprising:
determining a first location and a first time zone that is assigned to the first location;
simultaneously displaying a first geographical representation of the first location and a first time element of the first location based on the first time zone;
determining a second location and a second time zone that is assigned to the second location based on received selection input; and
simultaneously displaying a second geographical representation of the second location and a second time element of the second location based on the second time zone.

2. The method according to claim 1, wherein the first or second time element includes a current, past, or future time at the first or second location, or a time difference between the current, past, or future time and a reference time.

3. The method according to claim 1, further comprising:
adjusting the first or second geographical representation; and
in response to the adjusting, displaying a third time element associated with a third location.

4. The method according to claim 1, further comprising displaying at least a portion of the boundaries of the first time zone or second time zone.

5. The method according to claim 4, further comprising:
adjusting the first or second geographical representation; and
in response to the adjusting, displaying at least a portion of the boundaries of a third time zone different from the first and second time zones, wherein at least a portion of the displayed boundaries of the third time zone are different from the displayed boundaries of the first or second time zones.

6. The method according to claim 5, wherein adjusting the first or second geographical representations includes scaling, rotating or scrolling the first or second geographical representations.

7. The method according to claim 1, further comprising:
determining a route between the first and second locations;
determining a route information element that includes a travel time associated with the route or an arrival time associated with the route; and
presenting the route information element.

8. The method according to claim 7, wherein presenting the route information element comprises superimposing the route information element over the first or second geographical representation when the first or second geographical representation is displayed.

9. A method of displaying temporal data associated with a location, comprising:
determining a first location based on input received at a computing device;
determining a first temporal setting that is associated with the first location;
displaying a first geographical representation of the first location; and
presenting the first temporal setting associated with the first location while displaying the first geographical representation of the first location.

10. The method according to claim 9, further comprising:
determining a second location based on input received at the computing device;
determining a second temporal setting that is associated with the second location;
displaying a second geographical representation of the second location; and
presenting the second temporal setting associated with the second location while displaying the second geographical representation of the second location.

11. The method according to claim 10, wherein presenting the first temporal setting and the second temporal setting comprises superimposing the first temporal setting over the first geographical representation when the first geographical representation is displayed and superimposing the second temporal setting over the second geographical representation when the second geographical representation is displayed.

12. The method according to claim 10, wherein the first geographical representation is associated with a first time zone and the second geographical representation is associated with a second time zone.

13. The method according to claim 12, wherein the first temporal setting is a current, past, or future time associated with the first time zone and the second temporal setting is a current, past, or future time associated with the second time zone.

14. The method according to claim 12, further comprising:
displaying at least a portion of the boundaries of the first time zone when the first geographical representation is displayed; and
displaying at least a portion of the boundaries of the second time zone when the second geographical representation is displayed.

15. The method according to claim 14, further comprising:
adjusting the first or second geographical representation; and
in response to the adjusting, displaying at least a portion of the boundaries of a third time zone different from the first and second time zones, wherein at least a portion of the displayed boundaries of the third time zone are different from the displayed boundaries of the first or second time zones.

16. The method according to claim 10, wherein the first and second locations are part of a route and further comprising the first and second temporal settings as part of a route representation that at least partially runs along the first and second displayed geographical representations.

17. The method according to claim 16, wherein the first or second temporal settings include a travel time associated with the route or an expected arrival time at the second location.

18. A computing device, comprising:
an interface that is configured to receive input from a user related to location selections;
a display that is configured to present viewable elements to the user; and
a processing unit, wherein the processing unit is configured to:
determine a first location based on input received at the interface;
determine a first temporal setting that is associated with the first location;
cause a first geographical representation of the first location to be displayed on the display; and
cause the first temporal setting associated with the first location to be displayed on the display while the first geographical representation of the first location is displayed on the display.

19. The computing device according to claim 18, wherein the display includes the interface or the display and the interface are part of a combined component.

20. The computing device according to claim 18, wherein the processing unit is further configured to determine time zone boundaries associated with the first location and to cause at least a portion of the time zone boundaries to be displayed on the display.

21. The computing device according to claim 18, wherein the processing unit is further configured to cause an adjustment of the first geographical representation and, in response to the adjustment, cause a second temporal setting associated with a second location to be displayed on the display.
